(19) United States
(12) Patent Application Publication
(10) Pub. No.: US 2016/0225496 A1
(43) Pub. Date: Aug. 4, 2016

(54) PROTECTOR AND BUSBAR MODULE

(71) Applicant: Sumitomo Wiring Systems, Ltd., Yokkaichi (JP)

(72) Inventors: Tetsuya Fujita, Yokkaichi (JP); Kaho Arai, Yokkaichi (JP)

(21) Appl. No.: 14/988,776

(22) Filed: Jan. 6, 2016

(30) Foreign Application Priority Data
Jan. 30, 2015 (JP) 2015-016430

(51) Int. Cl. H01B 17/60; H01B 7/00

(52) U.S. Cl. CPC H01B 17/60; H01B 7/0081

(57) ABSTRACT

A protector (20) includes a main body (22) shaped along an extending direction of a member to be protected and a lid (40) capable of surrounding the member to be protected together with the main body (22). Further, the protector (20) includes a pressing piece (46) including a first hinge (48) having one end connected to an outward facing surface of the lid (40) and a projecting piece (50) connected to the other end of the first hinge (48), the lid (40) and the projecting piece (50) being biased in opening directions by the first hinge (48), a lock (30) provided on the main body (22), and a locked portion (52) provided on the projecting piece (50) and lockable to the lock (30) with the projecting piece (50) held close to the outward facing surface of the lid (40).

### BACKGROUND

1. Field of the Invention

The invention relates to a protector for protecting a member to be protected.

2. Description of the Related Art

A protector for protecting a wiring harness is disclosed, for example, in Japanese Unexamined Patent Publication No. 2005-318740 or Japanese Unexamined Patent Publication No. 2004-357415. The protectors described in Japanese Unexamined Patent Publication No. 2005-318740 and Japanese Unexamined Patent Publication No. 2004-357415 are configured so that a main body and a lid are connected by a hinge. A lock claw and a lock frame are locked on a side opposite to the hinge.

However, depending on the protector, the main body and the lid may not be connected on an opposite side facing the lock across an accommodation space and the lock may not be provided. In this case, the side of the lid opposite the lock may be lifted relative to the main body and a member to be accommodated may be caught between the main body and the lid or external matter may enter the accommodation space.

Accordingly, the invention aims to provide a technology capable of suppressing the lift of a lid relative to a main body.

### SUMMARY

The invention relates to a protector with a main body shaped substantially along an extending direction of a member to be protected and a lid that cooperates with the main body for at least partly surrounding the member to be protected. The protector further has at least one pressing piece including a first hinge with a first end connected to the lid and a projecting piece connected to the second end of the first hinge. The lid and the projecting piece are biased in opening directions by the first hinge. At least one lock is provided on the main body, and at least one locked portion is provided on the projecting piece. The lockable portion locks to the lock with the projecting piece held close to the lid. Thus, a lift of the lid relative to the main body can be suppressed by the action of a reaction force caused by the resilient deformation of the pressing piece in a direction to press the lid.

In one embodiment, the first end of the first hinge is connected to an outward facing surface of the lid.

The locked portion may be lockable to the lock with the projecting piece held close to the outward facing surface of the lid.

The main body and the lid may be connected via a second hinge at a position distant from the lock along an extending direction of the main body. Thus, the lid is lifted easily relative to the main body. Even in this case, the lift of the lid relative to the main body can be suppressed since the reaction force caused by the resilient deformation of the pressing piece acts in the direction to press the lid.

The lock and the locked portion may be locked between the first and second hinges along the extending direction of the main body. Thus, a reaction force caused by resilient deformation of the pressing piece acts on a side more distant from the second hinge along the extending direction of the lid. Therefore, the lift of the lid relative to the main body can be suppressed more reliably.

Extending directions of the first and second hinges may be substantially parallel. Thus, the reaction force of the second hinge is canceled out easily by that of the first hinge. This enables the lift of the lid relative to the main body to be suppressed more reliably.

A busbar may be accommodated as the member to be protected. Accordingly, one embodiment of the invention relates to a busbar module that includes the above described protector and a busbar at least partly accommodated in the protector. Thus, a possibility of a short circuit caused by the entrance of external matter or the like through a clearance formed by the lift can be suppressed by preventing a lift of the lid relative to the main body.

These and other objects, features and advantages of the invention will become more apparent upon reading of the following detailed description of preferred embodiments and accompanying drawings.

### BRIEF DESCRIPTION OF THE DRAWINGS

FIG. 1 is a perspective view of a protector according to an embodiment.

FIG. 2 is a front view of the protector of FIG. 1.

FIG. 3 is a perspective view showing a lid of the protector closed.

FIG. 4 is a front view showing the lid of the protector is closed

FIG. 5 is a perspective view showing a state where the protector is locked.

FIG. 6 is a front view showing the state where the protector is locked.

FIG. 7 is a rear view showing the state where the protector is locked.

FIG. 8 is a bottom view showing the state where the protector is locked.

FIG. 9 is a section along IX-IX of FIG. 8.

### DETAILED DESCRIPTION

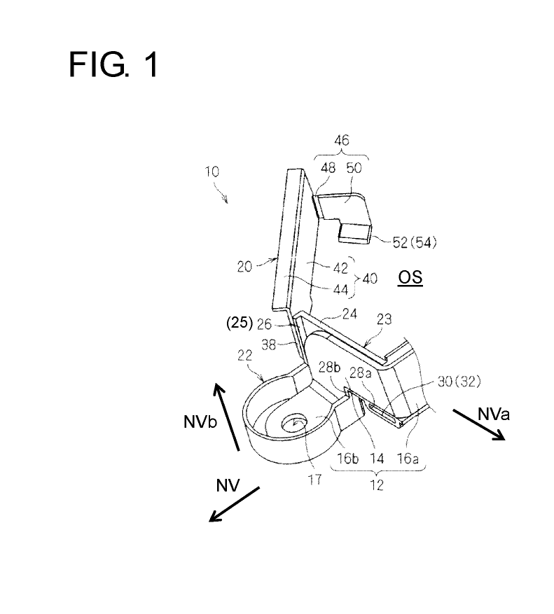

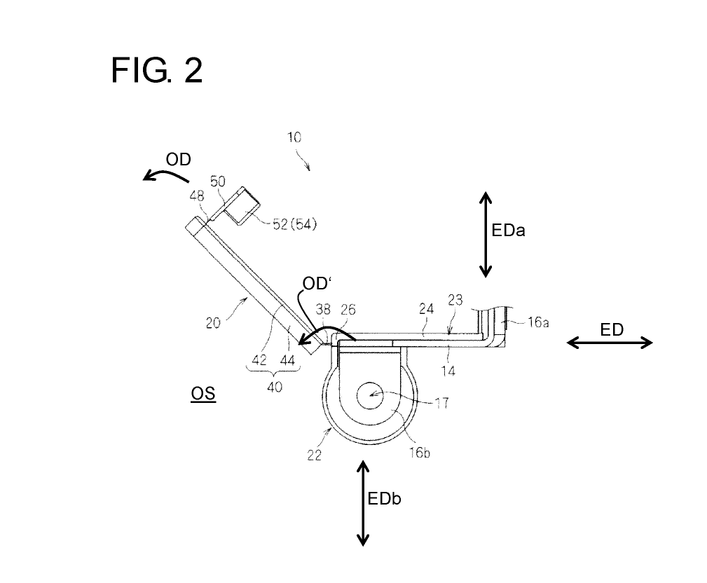

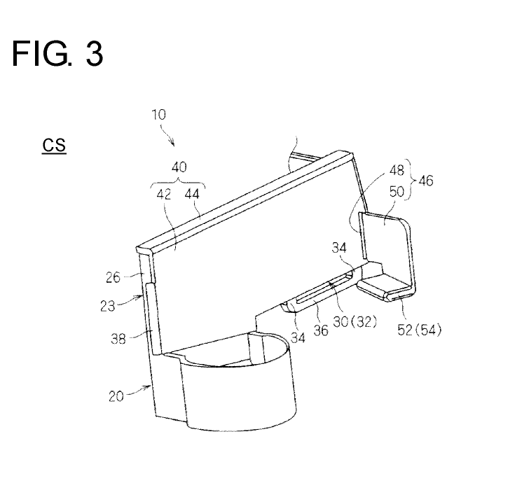

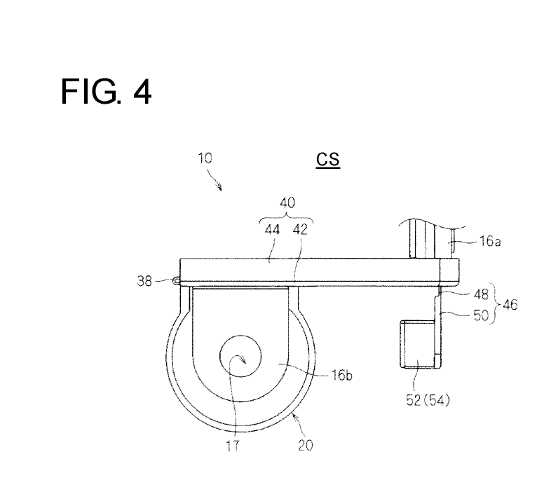

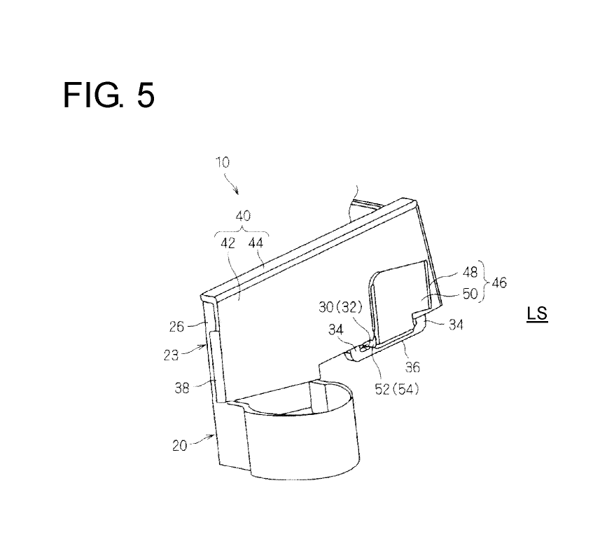

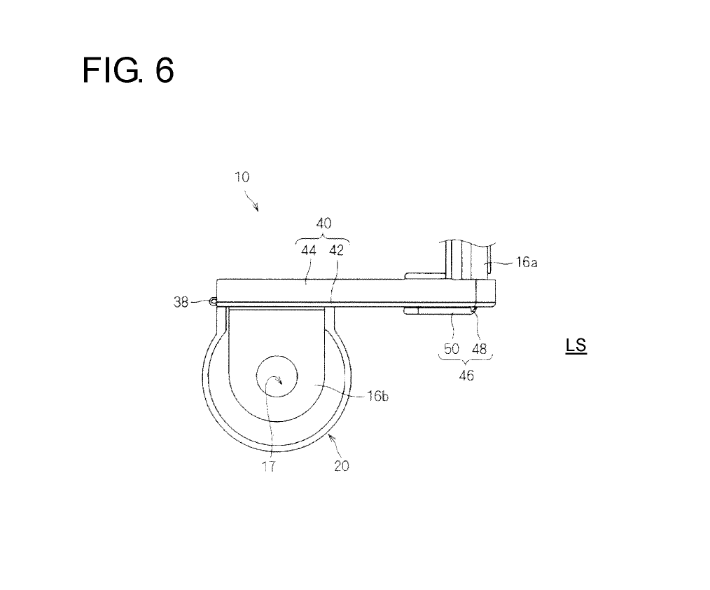

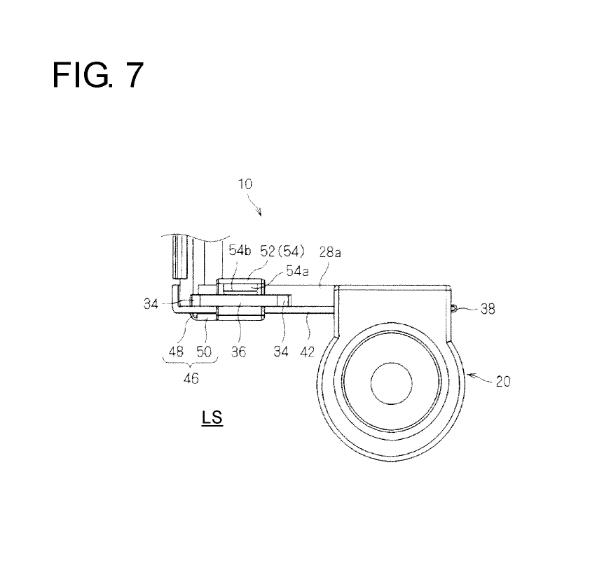

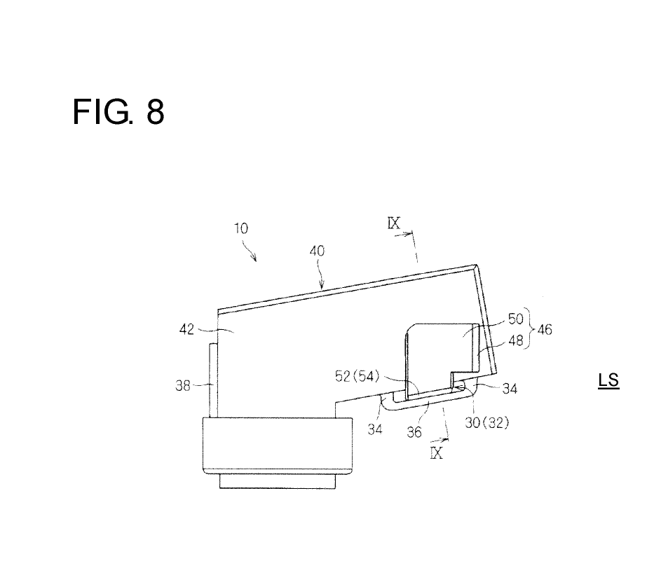

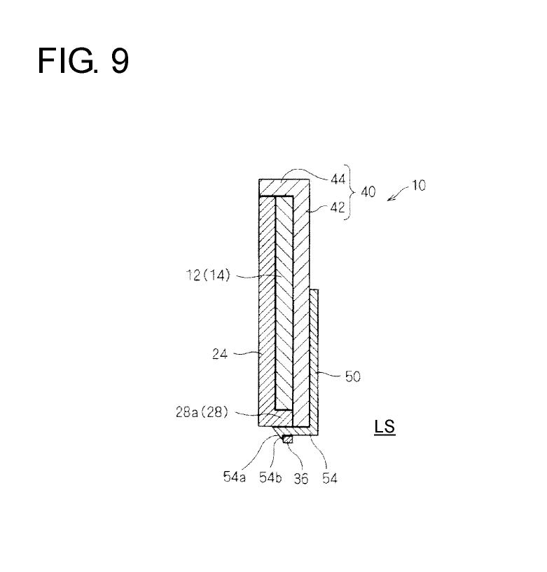

A protector 20 according to an embodiment is described with reference to FIGS. 1 to 9. FIGS. 1 and 2 are views showing a state where a lid 40 of the protector 20 is open (opened state OS), FIGS. 3 and 4 are views showing a state where the lid 40 of the protector 20 is closed (closed state CS), and FIGS. 5 to 9 are views showing a state where the protector 20 is locked (locked state LS). Note that FIGS. 1, 3 and 5 are perspective views and FIGS. 2, 4 and 6 are front views. Further, FIG. 7 is a rear view and FIG. 8 is a bottom view. Further, FIG. 9 is a section along IX-IX of FIG. 8. Note that FIGS. 3 and 5 are perspective views viewed from the same direction, and FIG. 1 is a perspective view viewed from a direction different from that of the FIGS. 3 and 5.

The protector 20 is a member for surrounding and protecting a member to be protected. Here, a busbar 12 is the member to be protected. A busbar module 10 is formed by at least partly accommodating the busbar 12 in the protector 20.

The busbar 12 is a conductive member, for example, made of metal such as copper, and plating, such as tin playing, may be applied to an outer layer of the busbar 12. The busbar 12 is laid as a part of a power transmission path to an electric drive device such as a motor.

The busbar 12 is formed by bending, folding and/or embossing a long flat plate member into a three-dimensional shape. Specifically, the busbar 12 is composed of an intermediate portion 14 and terminals 16a, 16b on or near opposite end parts of the intermediate portion 14. The terminals 16a, 16b on the end parts and the intermediate portion 14 are bent so that principal surfaces of the terminals 16a, 16b and that of the intermediate portion 14 are arranged at an angle, preferably substantially orthogonal along lines orthogonal to extending directions of the terminals 16a, 16b. In other words, extension directions EDa, EDb of the terminals 16a, 16b preferably are substantially perpendicular to an extension direction ED of the intermediate portion 14. The same holds true for a normal vector NV of the intermediate portion 14 being arranged substantially perpendicular to a normal vector NVa of the terminal 16a and/or to a normal vector NVb of the terminal 16b. Further, the intermediate portion 14 is bent in the same plane (or along one or more lines lying in the same plane as the intermediate portion 14). Note that the terminal 16a on one end part and the intermediate portion 14 are bent with one principal surface of the busbar 12 located at an inner side and the terminal 16b on the other end part and the intermediate portion 14 are bent with the other principal surface of the busbar 12 at an inner side. In other words, the terminals 16a and 16b are bent towards substantially opposite sides of the intermediate portion 14.

Each terminal 16a, 16b of the busbar 12 has a through hole 17. Using these through holes 17, the busbar 12 is connected to an object to be connected, for example, as follows. Specifically, threaded electrodes are inserted through the through holes 17 and nuts are mounted on the electrodes inserted through the through holes 17 to connect the busbar 12 electrically to the electrodes.

The protector 20 includes a main body 22, the lid 40, a pressing piece 46, a lock 30 and a locked portion 52. It is assumed that the protector 20 described here is molded integrally or unitarily from a material such as resin using a mold.

The main body 22 is shaped along an extending direction ED of the member to be protected (e.g. of the busbar 12, particularly of the intermediate portion 14). Here, a bottom surface 24 of the main body portion 22 is formed substantially along an extending direction ED of the busbar 12 and in contact with the one principal surface of the busbar 12.

The lid 40 is formed to surround the member to be protected together with the main body 22, and specifically is provided to surround the intermediate portion 14 of the busbar 12.

The pressing piece 46 includes a first hinge 48 and a projecting piece 50. The pressing piece 46 projects from an outward facing surface of the lid 40.

One end of the first hinge 48 is connected to the outward facing surface of the lid 40. The first hinge 48 is made more easily bendable than a surrounding part (here, projecting piece 50 or lid 40). The lid 40 and the projecting piece 50 are biased in opening directions OD by the first hinge 48 or in a direction increasing the azimuthal direction of the projecting piece 50 from the locked portion 52.

The projecting piece 50 is connected to the other end of the first hinge 48. When the projecting piece 50 approaches the lid 40 against a biasing force of the first hinge 48 (or in a direction opposite to the opening direction OD), the first hinge 48 is deformed resiliently.

The lock 30 is provided on the main body 22, and a lock recess or hole 32 is adopted as the lock 30.

The locked portion 52 is provided on the projecting piece 50. The locked portion 52 is formed to be lockable to the lock 30 with the projecting piece 50 held close to the outward facing surface of the lid 40. The pressing piece 46 is deformed resiliently against the biasing force with the locked portion 52 locked to the lock 30. Thus, the lid 40 is pressed toward the main body 22 by the pressing piece 46 and a lift between the lid 40 and the main body 22 is suppressed. Here, a lock claw 54 is adopted as the locked portion 52.

The main body 22 has an intermediate main body 23 covering the intermediate portion 14 of the busbar 12. The intermediate main body 23 has a bottom surface 24 that is bent in the same plane to extend along the intermediate portion 14 of the busbar 12. A side wall 25 projects from the bottom surface 24 of the intermediate main body 23 to cover a part of an outer side surface including an outer peripheral side of a bent part of a side surface of the intermediate portion 14 of the busbar 12 and an inner side surface including an inner peripheral side of the bent part. A part of the side wall 25 of the main body portion 22 covering the outer side surface of the busbar 12 is referred to herein as an outer side wall 26 and a part thereof covering the inner side surface of the busbar 12 is referred to as an inner side wall 28. A part of the inner side wall 28 extending from the terminal 16a of the busbar 12 is referred to as a first inner side wall portion 28a and a part thereof extending from an end part of the first inner side wall portion 28a toward the terminal 16b of the busbar 12 to intersect with the first inner side wall portion 28a is referred to as a second inner side wall portion 28b. The outer side wall 26 is not provided on a side opposite to the first inner side wall 28a and the outer side wall portion 26 is provided parallel to the second inner side wall 28b on a side opposite to the second inner side wall 28b.

Further, the lid 40 includes a ceiling plate 42 covering the other principal surface of the intermediate portion 14 of the busbar 12 and a side wall 44 covering an outer side surface of the intermediate portion 14 of the busbar 12 from a part of the main body 22 where the outer side wall 26 is not provided. The side wall 44 extends substantially parallel to the first inner side wall portion 28a with the lid 40 closed.

The main body 22 and the lid 40 are connected via a second hinge 38. Specifically, one end of the second hinge 38 is connected to an outward facing surface of the tip of the outer side wall portion 26 of the main body portion 22 and the other end of the second hinge 38 is connected to the ceiling plate 42 of the lid 40. An extending direction (direction orthogonal to a direction connecting the main body 22 and the lid 40) of the second hinge 38 is substantially parallel to that of the outer side wall 26. The second hinge 38 is made more easily bendable than surrounding members (here, lid 40 and main body 22), for example, by being thinner than the surrounding members.

The main body 22 and the lid 40 are connected at a position distant from the lock 30 along an extending direction of the main body 22. Specifically, the main body 22 and the lid 40 are connected by the second hinge 38 provided on the outer side wall 26 of the main body 22 as described above. Further, the lock 30 is provided on the first inner side wall portion 28a. Thus, the main body 22 and the lid 40 are connected at the position distant from the lock 30 along the extending direction of the main body 22.

The lock 30 and the locked portion 52 are locked between the first and second hinges 48, 38 along the extending direction of the main body 22. Further, an extending direction of the first hinge 48 and that of the second hinge 38 are parallel. Specifically, the first hinge 48 is provided at a position near the terminal 16a on an outward facing surface of the ceiling plate 42. The extending direction of the first hinge 48 (direction orthogonal to a direction connecting the ceiling plate 42 and the projecting piece 50 on a surface of the ceiling plate 42) is parallel to a part of the outer edge of the ceiling plate 42 facing and extending along the outer side wall 26 of the main body 22. Thus, the extending direction of the first hinge 48 and that of the second hinge 38 are parallel.

The first hinge 48 is made more easily bendable than surrounding members (here, projecting piece 50 and lid 40), for example, by being formed to be thinner than the surrounding members. If the first hinge 48 is thin, the first hinge 48 can bias the projecting piece 50 and the lid 40 in opening directions by integrally or unitarily molding the pressing piece 46 and the lid 40 with the projecting piece 50 and the lid 40 in an open state.

The projecting piece 50 is a flat plate and one principal surface thereof is held in contact with or faces the outward facing surface of the ceiling plate 42 with the lock 30 and the locked portion 52 locked to each other. At this time, the projecting piece 50 is tilted toward the second hinge 38. In this way, the lid 40 is closed and the projecting piece 50 is tilted toward the lid 40, and the locked portion 52 provided on the tip of the projecting piece 50 is locked to the lock portion 30 between the first and second hinges 48, 38.

The projecting piece 50 is formed into a substantially L shape because the ceiling plate 42 is bent at an obtuse angle in the same plane and the extending directions of the first hinge 48 and the second hinge 38 are parallel and because of the position of the lock 30. The shape of the projecting piece 50 is not so limited. The shape of the projecting piece 50 may be appropriately set if the locked portion 52 provided on the projecting piece 50 is lockable to the lock 30 provided on the main body 22.

Specific shapes of the lock 30 and the locked portion 52 are described here. The lock claw 54 is the locked portion 52 and the lock recess 32, into which the lock claw 54 is fittable, is the lock portion 30. Specifically, the lock claw 54 constituting the locked portion 52 projects from a side edge part of the projecting piece 50 orthogonally to the principal surface of the projecting piece 50. More specifically, the lock claw 54 projects on the principal surface of the projecting piece 50 facing the outward facing surface of the ceiling plate 42 when the projecting piece 50 is tilted in the direction toward the second hinge 38. Further, a thick portion 54a is provided on a tip part of the lock claw 54 and gradually thickens from a tip side toward a base end side of the lock claw 54. Further, a step 54b is created on a base end edge part of the thick portion 54a.

The lock 30 includes two first frame body pieces 34 projecting on the first inner side wall portion 28a of the main body 22 near the terminal portion 16a while being spaced apart in the extending direction of the main body 22 (corresponding to the extending direction ED of the intermediate portion 14) and a second frame body piece 36 connecting the tips or distal portions of the first frame body pieces. In this way, a space enclosed by the first inner side wall portion 28a of the main body 22, the first frame body pieces 34 and the second frame body piece 36 function as the lock recess or hole 32.

A distance between the inner surfaces of the first frame body pieces 34 is equal to or longer than a width of the lock claw 54. Here, since the projecting piece 50 and the locked portion 52 rotate about the first hinge 48 when the lock 30 and the locked portion 52 are locked, the distance between the inner surfaces of the first frame body pieces 34 is set longer than the width of the lock claw 54 so that the projecting piece 50 and the locked portion 52 are lockable while rotating.

Further, a distance between the outer surface of the first inner side wall portion 28a of the main body 22 and the inner surface of the second frame body piece 36 is set shorter than a thickness of a thickest part of the thick portion 54a of the lock claw 54.

Note that the protector 20 is produced by being molded integrally or unitarily from the material such as resin using the mold as described above here. This causes various restrictions on the shape of the protector 20. For example, the lid 40 and the main body 22 are biased in opening directions OD′ by the second hinge 38. Thus, the main body 22 and the lid 40 are lifted easily. This particularly is due to integral or unitary molding with the main body portion 22 and the lid portion 40 in an open state and the like. Further, the outer side wall 26 is not provided on the side of the main body portion 22 opposite to the first inner side wall portion 28a. Thus, it is difficult to adopt a lock structure or a hinge structure on the side opposite to the lock 30. This is because of the presence of another part of the mold on the side opposite to the lock 30. The restrictions as described above are caused mainly to facilitate the removal of the mold.

To lock the lock claw 54 and the lock recess 32, the lid 40 first is closed to approach the main body 22 and the projecting piece 50 is brought closer to the lid 40. This causes the lock claw 54 to be inserted gradually into the lock recess 32.

As the lock claw 54 is inserted into the lock recess 32, the thick portion 54a of the lock claw 54 is caught by an inner peripheral edge part of the lock recess 32. If a force is further applied in this state, the lock claw 54 is deformed resiliently to slightly thin the thick portion 54a of the lock claw 54 and at least one of the first inner side wall portion 28a and the second frame body pieces 36 is deformed resiliently to widen the distance between the outer surface of the first inner side wall portion 28a of the main body 22 and the inner surface of the second frame body piece 36. Thus, the thick portion 54a of the lock claw 54 is inserted into the lock recess 32. When the thick portion 54a of the lock claw 54 passes over the lock recess 32, the resilient deformation thereof is alleviated and the step 54b of the lock claw 54 is caught by the bottom surface 24 of the second frame body piece 36 and the lid 40 and the main body 22 are locked.

The lock 30 and the locked portion 52 lock the lid 40 and the main body 22 at the position of the first inner side wall portion 28a. Thus, the lid 40 is difficult to lift relative to the main body 22. Further, the lid 40 and the main body 22 are connected via the second hinge 38 at the position of the outer side wall 26, the lid 40 is difficult to lift relative to the main body 22 due to a reaction force of the second hinge 38 biasing the lid 40 in the opening direction OD′. However, the lid 40 and the main body 22 are neither locked nor connected on the side opposite to the first inner side wall portion 28a, and are lifted easily. The lid 40 is provided with the pressing piece 46 to make these parts difficult to lift.

Specifically, when the lock claw 54 is inserted into the lock recess 32, the projecting piece 50 is tilted toward the ceiling plate 42 of the lid 40 while being rotated about the first hinge 48 to approach the second hinge 38 (in a direction substantially opposite to the opening direction OD). At this time, the first hinge 48 is bent and deformed resiliently. The first hinge 48 is maintained in a resiliently deformed state with the lock claw 54 and the lock recess 32 locked. Thus, a reaction force caused by the resilient deformation of the first hinge 48 is applied to the ceiling plate 42 of the lid 40 with the lock claw 54 and the lock recess 32 locked. This reaction force acts in a direction to press the ceiling plate 42. Thus, the lift of the lid 40 relative to the main body 22 can be suppressed.

At this time, if the main body 22 and the lid 40 are connected via the second hinge 38 at a position distant from the lock 30 along the extending direction of the main body 22, the lid 40 is lifted easily relative to the main body portion 22 by the reaction force of the second hinge 38.

If the lock 30 and the locked portion 52 are locked between the first and the second hinges 48, 38 along the extending direction of the main body 22, a reaction force caused by the resilient deformation of the pressing piece 46 acts on a side more distant from the second hinge 38 along the extending direction of the lid 40 from the first hinge 48 to the second hinge 38. Therefore the lift of the lid 40 relative to the main body 22 can be suppressed more reliably.

Further, if the extending directions of the first and second hinges 48 are parallel, a reaction force of the second hinge 38 is canceled out easily by that of the first hinge 48. This enables the lift of the lid 40 relative to the main body 22 to be suppressed more reliably.

The protector 20 according to the embodiment includes the main body 22 shaped along the extending direction of the member (e.g. the extending direction ED of the intermediate portion 14) to be protected. The lid 40 is capable of surrounding the member to be protected together with the main body 22. The pressing piece 46 includes the first hinge 48 having the one end connected to the outward facing surface of the lid 40 and the projecting piece 50 is connected to the other end of the first hinge 48. The lid 40 and the projecting piece 50 are biased in the opening directions OD by the first hinge 48. The lock 30 on the main body 22 and the locked portion 52 on the projecting piece 50 and lockable with the projecting piece 50 held close to the outward facing surface of the lid 40. Thus, the lift of the lid 40 relative to the main body 22 can be suppressed by the action of a reaction force caused by the resilient deformation of the pressing piece 46 in a direction to press the lid 40.

The main body 22 and the lid 40 are connected via the second hinge 38 at the position distant from the lock 30 along the extending direction of the main body 22. Thus, the lid 40 is lifted easily relative to the main body 22. Even in this case, the lift of the lid 40 relative to the main body 22 can be suppressed since the reaction force caused by the resilient deformation of the pressing piece 46 acts in the direction to press the lid 40.

The lock 30 and the locked portion 52 are locked between the first and second hinges 48, 38 along the extending direction of the main body 22. Thus, a reaction force caused by the resilient deformation of the pressing piece 46 acts on the side more distant from the second hinge 38 along the extending direction of the lid 40. Therefore the lift of the lid 40 relative to the main body 22 can be suppressed more reliably.

The extending direction of the first hinge 48 and that of the second hinge 38 are substantially parallel. Thus, the reaction force of the second hinge 38 is easily canceled out by that of the first hinge 48. This enables the lift of the lid 40 relative to the main body 22 to be suppressed more reliably.

Further, since the busbar 12 is accommodated as the member to be protected, a possibility of a short circuit caused by the entrance of an external matter or the like through a clearance formed by the lift can be suppressed by suppressing the lift of the lid 40 relative to the main body 22.

The outer side wall is not provided on the side of the main body opposite to the first inner side wall portion 28a across the accommodation space for the busbar 12 in the illustrated embodiment. However, an outer side wall may be provided on the side opposite to the first inner side wall portion 28a. In this case, a lock, a second hinge or the like may be also provided on the outer side wall portion on the side opposite to the first inner side wall portion 28a.

The lock 30 is provided between the first and second hinges 48, 38 with the lid 40 closed. However, the first hinge may be on a side closer to the second hinge than the lock. In this case, the projecting piece is tilted in a direction away from the second hinge to lock the lock and the locked portion.

The extending directions of the first hinge 48 and the second hinge 38 are substantially parallel with the lid 40 closed in the illustrated embodiment. However, the extending directions of the first hinge 48 and the second hinge 38 may not be parallel. For example, it is also considered to set the extending direction of the first hinge in a direction along the extending direction of the lid (extending direction of the intermediate portion of the busbar). In this case, the projecting piece is tilted toward the lock along a direction (width direction of the lid) orthogonal to the extending direction of the lid.

Although the protector 20 is molded integrally or unitarily from resin or the like in the embodiment, this is not essential. The protector 20 may be formed by combining a plurality of separately formed members. For example, the lid portion and the pressing piece may be separately formed. In this regard, the thin form of the first hinge 48 is not essential. Another configuration such as a springy hinge, i.e. a so-called spring hinge, may be adopted as the first hinge. That is, the first hinge has only to be able to bias the projecting piece in the opening direction and resiliently deformable in a direction to close the projecting piece.

The lid and the main body may be formed separately without being connected. In this case, a lock and a locked portion may be provided at the position of the second hinge.

The lock recess 32 is adopted as the lock 30 and the lock claw 54 is adopted as the locked portion 52 in the illustrated embodiment, but this is not essential. For example, a lock claw may be adopted as the lock and a lock recess may be adopted as the locked portion.

The protector 20 protects the busbar 12 in the illustrated embodiment, but the object to be protected is not limited to the busbar. The object to be protected by the protector may be, for example, a wire, a wiring harness or the like.

Note that the respective configurations described in the above embodiment and each modification can be appropriately combined unless they contradict each other.

Although this invention has been described in detail above, the above description is illustrative in all aspects and this invention is not limited thereby. It should be understood that unillustrated numerous modifications can be made without departing from the scope of this invention.

### REFERENCE SIGNS

10 busbar module
12 busbar (member to be protected)
20 protector
22 main body
30 lock
38 second hinge
40 lid
46 pressing piece
48 first hinge
50 projecting piece
52 locked portion

What is claimed is:

1. A protector (20), comprising:
a main body (22) shaped substantially along an extending direction (ED) of a member (12) to be protected;
a lid (40) capable of at least partly surrounding the member (12) to be protected together with the main body (22);
at least one pressing piece (46) including a first hinge (48) having a first end connected to the lid (40) and a projecting piece (50) connected to a second end of the first hinge (48), the lid (40) and the projecting piece (50) being biased in opening directions (OD) by the first hinge (48);
at least one lock (30) provided on the main body portion (22); and
at least one locked portion (52) provided on the projecting piece (50) and lockable to the lock (30) with the projecting piece (50) held close to the lid (40).

2. The protector of claim 1, wherein the first end of the first hinge (48) is connected to an outward facing surface of the lid (40).

3. The protector of claim 2, wherein the locked portion (52) is lockable to the lock (30) with the projecting piece (50) held close to the outward facing surface of the lid (40).

4. The protector of claim 1, wherein the main body (22) and the lid (40) are connected via a second hinge (38) at a position distant from the lock (30) along an extending direction of the main body (22).

5. The protector of claim 4, wherein the lock (30) and the locked portion (52) are locked between the first and second hinges (48, 38) along the extending direction of the main body (22).

6. The protector of claim 5, wherein extending directions of the first and second hinges (48, 38) are set to be substantially parallel.

7. The protector of claim 1, wherein a busbar (12) at least partly is accommodated as the member (12) to be protected.

8. A busbar module (10), comprising:
the protector (20) of claim 1; and
a busbar (12) to be at least partly accommodated in the protector (20).
